(19) United States
(12) Patent Application Publication
(10) Pub. No.: US 2022/0245686 A1
(43) Pub. Date: Aug. 4, 2022

(54) METHOD AND SYSTEM FOR GENERATING RECOMMENDATIONS FOR USERS

(71) Applicant: HCL America Inc., Sunnyvale, CA (US)

(72) Inventors: Michael Hudson, Florida, FL (US); John William Barrs II, Florida, FL (US)

(73) Assignee: HCL America Inc.

(21) Appl. No.: 17/162,293

(22) Filed: Jan. 29, 2021

(51) Int. Cl. G06Q 30/02; G06Q 50/00; G06F 40/20

(52) U.S. Cl. CPC G06Q 30/0282; G06F 40/20; G06Q 50/01

(57) ABSTRACT

The disclosed method and system relate to generating recommendations for a user. In some embodiments, the method includes capturing organization data with respect to organizations and user data with respect to the user; determining news feed data and social feed data from online platforms, based on the organization data and the user data; analysing the news feed data and the social feed data to determine stand of the each organization and stand of the user on one or more socio-ethical causes; determining match data associated with the user for a predefined time period, based on the user data, the organization data, and the analysis of the news feed data and the social feed data; and controlling user equipment associated with the user during an online browsing session involving at least one of a product and a service offered by at least one of the organizations.

### TECHNICAL FIELD

Generally, one or more embodiments of the present disclosure relate to website data analytics. More specifically, certain embodiments of the present disclosure relate to a method and system for generating recommendations associated with products and services for users in which the users have shown interest.

### BACKGROUND

Presently, consumers globally trust brands that demonstrate commitment to a cause or sincerity in their promises. The cause may include, but not limited to, a social cause, a political cause, management diversity, involvement with repressive international regimes, environmental destructiveness, and cruelty to animals in product testing. The consumers may buy or boycott one or more brands because of position of the brands on social issues or political issues. A substantial percentage of the consumers who feel that a company is behaving wrongly (such as, not treating the employees fairly) may be willing to express disapproval by withholding their money on the company or prioritizing the purchasing of brands that support causes. Therefore, recently belief driven consumers have become the majority across markets.

These days certain campaign organisations publish information for consumers related to curated boycott lists on the social, ethical and environmental behavior of companies and issues around trade justice and ethical consumption. However, the problem is that such curated boycott lists may be biased in favor of whoever curates the boycott lists. In certain scenarios, consumers may be looking at the wrong list when such consumers have a specific and differing point of view. In certain other scenarios, keeping up with who to boycott and why to boycott may become challenging with the frequency of news stories about who's boycotting who.

Accordingly, there is a need for a system and method that assists consumers by choosing brands whose stand on values connect to values of consumers and thereby, the need for delivering a highly personalized experience to consumers when the consumers are about to make a purchase online.

### SUMMARY

In one embodiment, a method for generating a recommendation for a user is disclosed. The method may include capturing organization data with respect to a set of organizations and user data with respect to the user. The organization data may include at least one of brand data, product data, and services data for each organization from the set of organizations, and the user data may include a profile of the user. The method may further include determining at least one of news feed data and social feed data from a set of online platforms, based on the organization data and the user data. The method may further include analysing the at least one of the news feed data and the social feed data to determine stand of each organization and stand of the user on one or more socio-ethical causes. The method may further include determining match data associated with the user for a predefined time period, based on the user data, the organization data, and the analysis of the at least one of the news feed data and the social feed data. The method may further include controlling user equipment associated with the user during an online browsing session involving at least one of a product and a service offered by at least one of the set of organizations, based on the match data.

In another embodiment, a system for generating recommendation for a user is disclosed. The system may include a processor and a memory communicatively coupled to the processor. The memory may store processor-executable instructions, which, on execution, may cause the processor to capture organization data with respect to a set of organizations and user data with respect to the user. The organization data may include at least one of brand data, product data, and services data for each organization from the set of organizations, and the user data may include a profile of the user. The processor-executable instructions, on execution, may further cause the processor to determine at least one of news feed data and social feed data from a set of online platforms, based on the organization data and the user data. The processor-executable instructions, on execution, may further cause the processor to analyse the at least one of the news feed data and the social feed data to determine stand of the each organization and stand of the user on one or more socio-ethical causes. The processor-executable instructions, on execution, may further cause the processor to determine match data associated with the user for a predefined time period, based on the user data, the organization data, and the analysis of the at least one of the news feed data and the social feed data. The processor-executable instructions, on execution, may further cause the processor to control user equipment associated with the user during an online browsing session involving at least one of a product and a service offered by at least one of the set of organizations, based on the match data.

In yet another embodiment, a non-transitory computer-readable medium storing computer-executable instruction for generating recommendation for a user is disclosed. The stored instructions, when executed by a processor, may cause the processor to perform operations including capturing organization data with respect to a set of organizations, and user data with respect to the user. The organization data may include at least one of brand data, product data, and services data for each organization from the set of organizations, and the user data may include a profile of the user. The operations may further include determining at least one of news feed data and social feed data from a set of online platforms, based on the organization data and the user data. The operations may further include analysing the at least one of the news feed data and the social feed data to determine stand of the each organization and stand of the user on one or more socio-ethical causes. The operations may further include determining match data associated with the user for a predefined time period, based on the user data, the organization data, and the analysis of the at least one of the news feed data and the social feed data. The operations may further include controlling user equipment associated with the user during an online browsing session involving at least one of a product and a service offered by at least one of the set of organizations, based on the match data.

It is to be understood that both the foregoing general description and the following detailed description are exemplary and explanatory only and are not restrictive of the invention, as claimed.

### BRIEF DESCRIPTION OF THE DRAWINGS

The present disclosure can be best understood by reference to the following description taken in conjunction with the accompanying drawing figures, in which like parts may be referred to by like numerals

FIG. 1 illustrates a block diagram of an exemplary system in a network environment for generating recommendations for users, in accordance with some embodiments of the present disclosure.

FIG. 2 illustrates a functional block diagram of an exemplary recommendation device, in accordance with some embodiments of the present disclosure.

FIG. 3 illustrates a flow diagram of an exemplary process for generating recommendation for a user, in accordance with some embodiments of the present disclosure.

FIG. 4 illustrates an exemplary scenario for generating recommendations on a user device, in accordance with some embodiments of the present disclosure.

### DETAILED DESCRIPTION OF THE DRAWINGS

The following description is presented to enable a person of ordinary skill in the art to make and use the invention and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the present invention is not intended to be limited to the embodiments shown, but is to be accorded the widest scope consistent with the principles and features disclosed herein.

While the invention is described in terms of particular examples and illustrative figures, those of ordinary skill in the art will recognize that the invention is not limited to the examples or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable storage media. Some other processes can be implemented using analog circuitry, as is well known to one of ordinary skill in the art. Additionally, memory or other storage, as well as communication components, may be employed in embodiments of the invention.

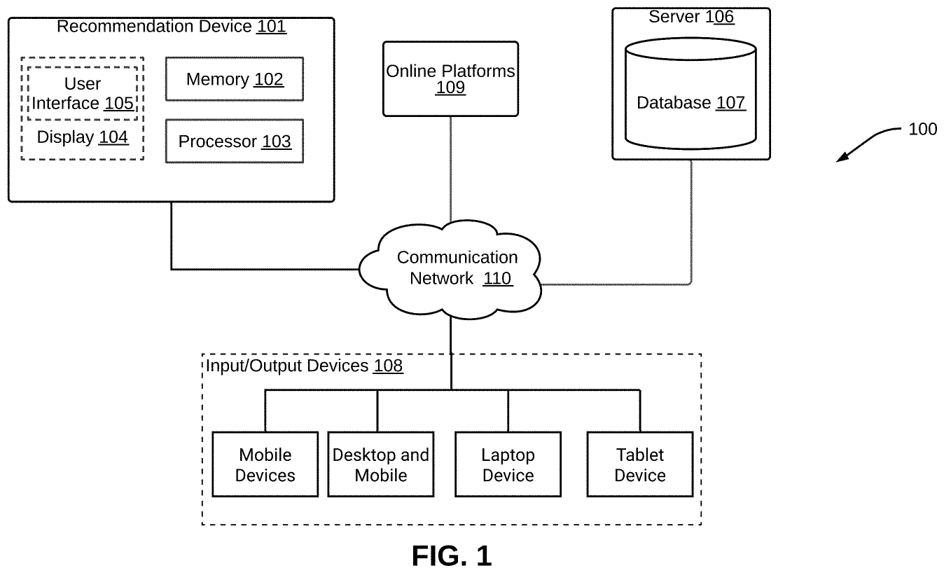

Referring now to FIG. 1, a block diagram of an exemplary system 100 for generating recommendations for users is illustrated, in accordance with some embodiments of the present disclosure. In an embodiment, the system 100 may be used to resolve aforementioned problems by automatically generating recommendations for users, using a recommendation device 101. In some embodiments, the recommendation device 101 may determine social positions of organizations, brands, and/or products for different users based on organizations' stand and users' respective stand on socio-ethical causes. By way of an example, in order to generate recommendations, the recommendation device 101 may determine news feed data and social feed data from input/output devices 108 or from online platforms 109. Examples of the recommendation device 101 may include, but are not limited to, a desktop, a laptop, a notebook, a netbook, a tablet, a smartphone, a remote server, a mobile phone, or another computing system/device.

The recommendation device 101 may include a memory 102, a processor 103, and a display 104. The display 104 may further include a user interface 105. A user or an administrator may interact with the recommendation device 101 and vice versa through the display 104. By way of an example, the display 104 may be used to show results of analysis (for example, to display recommendations and associated tags) performed by the recommendation device 101, to the user. By way of another example, the user interface 105 may be used by the user/administrator to provide inputs (for example, a product name or a service of interest, preconfigured stand on one or more socio-ethical causes, and vote of the user on a stand) to the recommendation device 101. Thus, for example, in some embodiments, the recommendation device 101 may ingest information such as, personal preferences of the user, preconfigured stand of the user on socio-ethical causes, demographic profile of the user, and votes of the user, via the user interface 105. Further, for example, in some embodiments, the recommendation device 101 may render search results to the user/administrator via the user interface 105. In some embodiments, the user/administrator may provide inputs to the recommendation device 101 via the user interface 105. In an embodiment, the data stored in a database 107 may be stored in the memory 102 of the recommendation device 101.

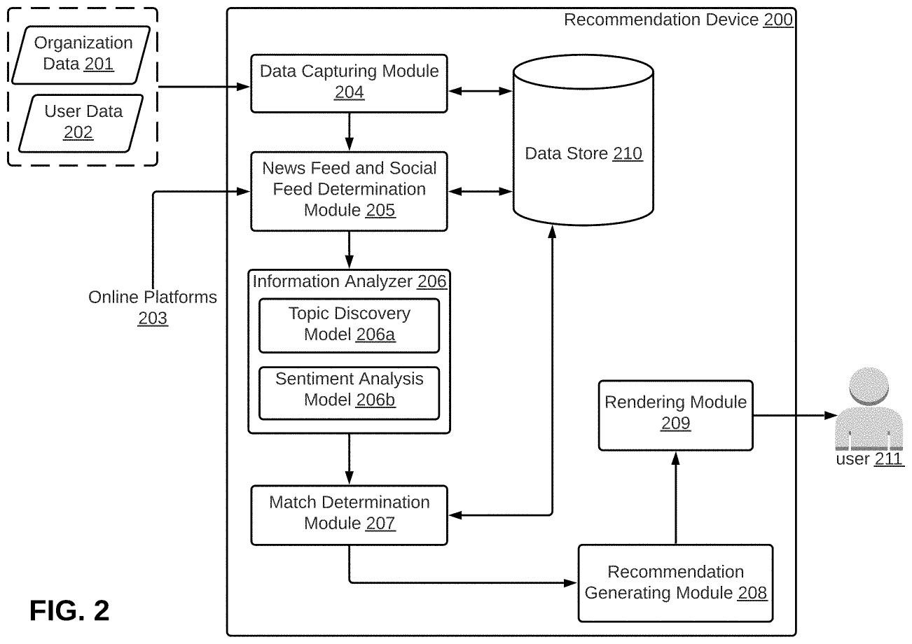

The memory 102 may store instructions that, when executed by the processor 103, may cause the processor 103 to provide recommendations to the users, in accordance with some embodiments. As will be described in greater detail in conjunction with FIG. 2 to FIG. 4, in order to provide recommendations to the users, the processor 103 in conjunction with the memory 102 may perform various functions including capturing user data and organization data, determining news feed data and social feed data, analyzing the news feed data and the social feed data, determining organization's stand, determining user's stand, determining match data, assigning tags, and generating recommendations.

The memory 102 may also store various data (e.g., user data, organization data, match data etc.) that may be captured, processed, and/or required by the recommendation device 101. The memory 102 may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.)

The system 100 includes a server 106 that further includes the database 107. Further, the system 100 includes the input/output devices 108 that may further include mobile devices, desktops, laptop devices and tablet devices (not labelled in the FIG. 1). The system 100 further includes the online platforms 109. The recommendation device 101, the server 106, the input/output devices 108 and the online platforms 109 may be communicatively coupled to each other via a communication network 110.

Further, the recommendation device 101 may interact with the server 106, the input/output devices 108, or the online platforms 109 via the communication network 110 for sending and receiving data, such as the organization data and the user data. The communication network 110, for example, may be any wired or wireless communication network and the examples may include, but may be not limited to, the Internet, Wireless Local Area Network (WLAN), Wi-Fi, Long Term Evolution (LTE), Worldwide Interoperability for Microwave Access (WiMAX), and General Packet Radio Service (GPRS).

By way of an example, in some embodiments, the recommendation device 101 may receive user data and organization data from the server 106 or the input/output devices 108, via the communication network 110. By way of another example, the recommendation device 101 may determine at least one of the news feed data and the social feed data from the online platforms 109. The server 106 may further include the database 107, which may store information related to the user, such as, personal preferences of the user, online browsing activities of the user, preconfigured stand of the user on the one or more socio-ethical causes, demographic profile of the user, social circle relations data of the user, responsiveness of the user to information on the internet, brand data, product data, and services data for each organization. In accordance with an embodiment, the recommendation device 101 may provide one or more queries in form of a survey to the user, based on interpretation of user actions. In addition, in accordance with an embodiment, on receiving a response for the one or more queries from the user, the recommendation device 101 may store in the server 106, the response as the preconfigured stand of the user as an implicit feedback from the user on the cause supported by the user. Alternatively, the recommendation device 101 may store the response as the preconfigured stand of the user in the memory 102 of the recommendation device 101.

The input/output devices 108 may be configured to receive information (such as, search details of products and/or services associated with organizations during an online browsing session) from users (such as, a user 211). The received information from the input/output devices 108 is stored in the memory 102. Examples of, the input/output devices 108 may include, but not limited to, a desktop, a laptop, a notebook, a netbook, a tablet, a smartphone, a remote server, a mobile phone, or another computing system/device.

Referring now to FIG. 2, a functional block diagram of an exemplary recommendation device 200 (similar to the recommendation device 101) is illustrated, in accordance with some embodiments of the present disclosure. The recommendation device 200 may be configured to generate recommendations for the user 211 based on organization data 201, user data 202, news feed data, and social feed data. The organization data 201 may include at least one of brand data, product data, and services data for each organization from a set of organizations. The user data 202 may include profiles of users (such as, the user 211). The user data 202 may include implicit user data (such as a survey filled by the user 211) and explicit user data based on user actions on internet, such as behavior of the user 211 towards services provided by service providers. To obtain the user data 202 in real-time, whenever the user 211 approaches any service provider for services, the recommendation device 200 establishes a connection between a user device of the user 211 and a server of a service provider based on a user location received from the user device. The user data 202 may include contact details, login credentials, historic user data associated with the user 211. A person skilled in the art would understand that the user data 202 may also include any other type of data not explicitly mentioned in the present disclosure.

Further, the news feed data and the social feed data may be determined from online platforms 203. The recommendation device 200 may help the user 211 to choose a suitable option by automatically providing flagged options. In some embodiments, a database of socio-ethical causes (for example, trending issues in news feed) may be generated. The database of socio-ethical causes may be maintained dynamically and new identified topics (i.e., socio-ethical causes) may always be added to the database of socio-ethical causes. Additionally, in some embodiments, a database of organizations, brands, products, and users may be generated. For example, the database of organizations may include a list of socio-ethical causes of interest, and their position (e.g., a pro-stand, a neutral-stand, and an anti-stand) with respect to the different socio-ethical causes. The database of users may include, but not limited to, demographic profile of users, and their position or stand with respect to different socio-ethical causes.

The recommendation device 200 may perform various functions to generate recommendations. In order to perform various functions, the recommendation device 200 may include various modules including a data capturing module 204, a news feed and social feed determination module 205, an information analyzer 206, a match determination module 207, a recommendation generating module 208, and a rendering module 209. Besides the modules 204-209, the recommendation device 200 may include a data store 210 which may store various data and intermediate results generated by the modules 204-209.

The data capturing module 204 may be configured to capture the organization data 201 and the user data 202. The data capturing module 204 may capture the organization data 201 from the set of organizations. In addition to the product data, the services data and the brand data, the organization data 201 may include stated stand of at least one of the set of organizations on one or more socio-ethical causes. Such stated stand of one or more organizations may be determined by the recommendation device 200 directly or indirectly from website content analytics techniques. The stated stand of the one or more organizations may be more pertinent organization data as compared to other factors that contribute to the organization data 201. The stated stand of at least one of the set of organizations may be based on one or more of social profile data, organization website data, and corporate social responsibility data associated with the at least one of the set of organizations.

Further, the user data 202 may include demographic profile and social media profile of the user 211. In particular, the user data 202 may be indicative of personal preferences of the user 211. Also, the user data 202 may include at least one of online browsing activities of the user, preconfigured stand of the user on the one or more socio-ethical causes, demographic profile of the user, social circle relations data of the user and user's responsiveness to information on the internet. In accordance with an embodiment, the pre-configured stand of the user 211 may be based on survey data filled by the user 211. The socio-ethical causes may include, but not limited to, social behavioral issues, political issues, management diversity, involvement with repressive international regimes, environmental destructiveness, and cruelty to animals in product testing. The pre-configured stand of the user 211 for a social cause may be more pertinent user data as compared to other factors that contribute to the user data 202 as that may reflect anything a user emotionally relates to. In some embodiments, tags may be assigned to the at least one of the set of organizations based on the preconfigured stand of the user 211. The data capturing module 204 may be communicatively coupled to the news feed and social feed determination module 205 to transmit the captured organization data 201 and the user data 202, and to the data store 210. Further, the news feed and social feed determination module 205 may be communicatively coupled to the information analyzer 206 and the data store 210.

The news feed and social feed determination module 205 may be configured to receive the organization data 201 and the user data 202 from the data capturing module 204. Based on the organization data 201 and the user data 202, the news feed and social feed determination module 205 may determine the news feed data and the social feed data from the online platforms 203. In the age of information, the amount of written material encountered each day from the news feed data and the social feed data may simply be beyond processing capacity of humans, such as the user 211. In accordance with an embodiment, a topic discovery model 206a may be used by the news feed and social feed determination module 205 to discover one or more topics (e.g., socio-ethical causes) from the news feed data and the social feed data for users, such as the user 211. The news feed and social feed determination module 205 may interact with the information analyzer 206 that may analyze the news feed data and the social feed data. In some embodiments, the topic discovery model 206a may be used by the information analyzer 206 to discover the one or more topics (e.g., the socio-ethical causes) and to analyze the news feed data and the social feed data. It should be noted that the information analyzer 206, by using the topic discovery model 206a, may identify the socio-ethical causes that generate interest at time of online browsing session by users (such as, the user 211), based on analysis of the news feed data and the social feed data.

The information analyzer 206 may generate insights from the news feed data and the social feed data for the user 211 using the topic discovery model 206a. Implementation of the topic discovery model 206a to discover one or more topics (the socio-ethical causes) may include, but not limited to, clustering techniques, and topic modelling techniques (such as, Latent Dirichlet Allocation (LDA)). The topic discovery model 206a may facilitate discovery of the one or more topics (the socio-ethical causes) to understand large collections of unstructured text bodies from the news feed data and the social feed data and discover hidden semantic structures to identify the socio-ethical causes from the news feed data and the social feed data.

In some embodiments, the news feed data and the social feed data may be analyzed using a sentiment analysis model 206b. For example, statistical analysis, machine learning (supervised or unsupervised), pattern matching, or other analytical methods may be used alone or in combination to analyze the news feed data and the social feed data. The sentiment analysis model 206b of the information analyzer 206 may determine stand of one or more organizations from the set of organizations and stand of the user 211 on one or more socio-ethical causes. Further, the information analyzer 206 may be operatively connected to the match data determination module 207.

The match determination module 207 may be configured to determine match data associated with the user 211 based on the organization data 201, the user data 202, and the analysis of the at least one the news feed data and the social feed data. The match determination module 207 may be communicatively coupled to the recommendation generating module 208.

The recommendation generating module 208 may be configured to generate a recommendation involving at least one of a product and a service offered by at least one of the set of organizations to the user 211, based on the match data. In some embodiments, user equipment associated with the user 211 may be controlled by the recommendation device 200 during an online browsing session. The online browsing session may involve a search performed by the user 211 for at least one of a product and a service offered by at least one of the set of organizations on a search engine. By way of an example, the user equipment may include, but are not limited to, a desktop, a laptop, a notebook, a netbook, a tablet, a smartphone, a mobile phone, or another computing system/device. Further, the recommendation generated by the recommendation generating module 208 may be a positive recommendation, a neutral recommendation, or a negative recommendation. The positive recommendation and the negative recommendation may indicate predicted possible acceptable choice and unacceptable choice respectively for the user 211. The neutral recommendation may correspond to a default recommendation. At least one of the news feed data and the social feed data may be determined and a sentiment analysis may be performed for generating the recommendations. Further, the recommendation generating module 208 may be operatively connected to the rendering module 209.

The rendering module 209 may be configured to render the recommendation to the user 211 when the search is performed by the user 211 associated with the at least one of the product and the service offered by at least one of the set of organizations during the online browsing session. In accordance with an embodiment, the search may include purchasing a product associated with at least one of the set of organizations. The recommendation device 200 may also include a user interface generating module (not shown in FIG. 2). The user interface generating module may generate a first user interface to receive the preconfigured stand of the user 211 on the one or more socio-ethical causes based on a user input. Further, the user interface generating module may also generate a second user interface that allows the user 211 to vote on a stand of the at least one of the set of organizations for at least one socio-ethical cause from the one or more socio-ethical causes. It may be noted that votes associated with the user 211 may be assigned with weights based on the user data 202.

It should be noted that the recommendation device 101, 200 may be implemented in programmable hardware devices such as programmable gate arrays, programmable array logic, programmable logic devices, or the like. Alternatively, the recommendation device 101, 200 may be implemented in software for execution by various types of processors. An identified engine/module of executable code may, for instance, include one or more physical or logical blocks of computer instructions which may, for instance, be organized as a component, module, procedure, function, or other construct. Nevertheless, the executables of an identified engine/module need not be physically located together but may include disparate instructions stored in different locations which, when joined logically together, comprise the identified engine/module and achieve the stated purpose of the identified engine/module. Indeed, an engine or a module of executable code may be a single instruction, or many instructions, and may even be distributed over several different code segments, among different applications, and across several memory devices.

As will be appreciated by one skilled in the art, a variety of processes may be employed for generating recommendation for users. For example, the exemplary system 100 and associated recommendation device 101 may generate recommendations, by the process discussed herein. In particular, as will be appreciated by those of ordinary skill in the art, control logic and/or automated routines for performing the techniques and steps described herein may be implemented by the system 100 and the associated recommendation device 101 either by hardware, software, or combinations of hardware and software. For example, suitable code may be accessed and executed by the one or more processors on the system 100 to perform some or all of the techniques described herein. Similarly, application specific integrated circuits (ASICs) configured to perform some or all the processes described herein may be included in the one or more processors on the system 100.

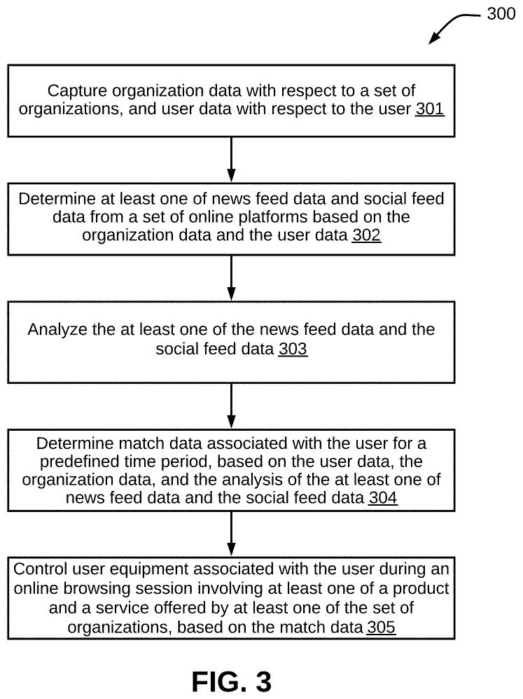

Referring now to FIG. 3, an exemplary process for generating recommendation for a user is depicted via a flow diagram 300, in accordance with some embodiments of the present disclosure. Each step of the process may be performed by a recommendation device (similar to the recommendation device 101 and 200). FIG. 3 is explained in conjunction with FIG. 1 and FIG. 2.

At step 301, organization data (for example, the organization data 201) and user data (for example, the user data 202) may be captured. It should be noted that the organization data may be captured with respect to a set of organizations and the user data may be captured with respect to the user (for example, the user 211). The organization data may include at least one of brand data, product data, and services data for each organization of the set of organizations, and the user data may include a profile of the user. To capture the organization data and the user data, the recommendation device employs a data capturing module (similar to the data capturing module 204).

At step 302, at least one of news feed data and social feed data may be determined from a set of online platforms (same as the online platforms 203). To determine the news feed data and the social feed data, a news feed and social feed determining module (analogous to the news feed and social feed determining module 205) may be employed. Thereafter, at step 303, the at least one of the news feed data and the social feed data may be analyzed. The analysis may be performed by an information analyzing module (similar to the information analyzer 206) using topic discovery and sentiment analysis techniques. Based on the analyzation, stand of the each organization and stand of the user on one or more socio-ethical causes (i.e., topics) may be determined. The socio-ethical causes may include, but not limited to, a behavioral issue, political issues, management diversity, involvement with repressive international regimes, environmental destructiveness, and cruelty to animals in product testing.

For example, in some embodiments, analyzation of the news feed data and the social feed data may include extraction of one or more socio-ethical causes from the news feed data and the social feed data, and determination of stand of the each organization and stand of the user on one or more socio-ethical causes. It should be noted that a topic discovery model (similar to the topic discovery model 206a) may be used to extract the one or more socio-ethical causes. Also, it should be noted that stand of the each organization and stand of the user on one or more socio-ethical causes may be determined based on a sentiment analysis model (similar to the sentiment analysis model 206b).

The user data may include, but not limited to, personal preferences of the user, online browsing activities of the user, preconfigured stand of the user on the one or more socio-ethical causes, demographic profile of the user, social media profiles of the user, social circle relations data of the user and responsiveness of the user to information on the internet. In some embodiments, the user's preconfigured stand on the one or more socio-ethical causes may be captured based on a user input via a first user interface. Additionally, in some other embodiments, vote of the user on the stand of the at least one of the set of organizations for at least one socio-ethical cause from the one or more socio-ethical causes may be captured via a second user interface. It should be noted that, based on the user data, weight may be assigned to the vote associated with the user. For example, the users' votes may be weighted based on a plurality of factors, such as social grouping.

Further, the organization data may include stated stand of the at least one of the set of organizations on the one or more socio-ethical causes. The stated stand of the at least one of the set of organizations may be based on one or more of social profile data, organization website data, and corporate social responsibility data associated with the at least one of the set of organizations.

Also, it should be noted that the preconfigured stand of the user and the stated stand of the at least one of the set of organizations may include one of a pro-stand, an anti-stand, and a neutral stand on the one or more socio-ethical causes. It should be noted that the pro-stand may generally indicate a favorable reaction, while the anti-stand may generally indicate unfavorable reaction on the socio-ethical cause. Further, it should be noted that the stand may be always a neutral stand until a user or organization react on the socio-ethical cause or a sentiment analysis is performed on the their news feed or social media feed.

At step 304, match data associated with the user may be determined for a predefined time period. The predefined time period may correspond to, but not limited to, an hour, a day, a fortnight, and 1 month. The match data may be determined based on the user data, the organization data, and the analysis of the at least one of the news feed data and the social feed data. It should be noted that the match data may be determined using a match determination module (similar to the match determination module 207).

At step 305, user equipment (for example, a laptop, a desktop, a computer, a mobile, and a tablet computer) associated with the user may be controlled by the recommendation device 200. The user equipment may be controlled during an online browsing session which may involve searching at least one of a product and a service offered by at least one of the set of organizations based on the match data. In some embodiments, the recommendation may be rendered on the user equipment when a search is performed by the user. The search may include at least one of the product and the service by at least one of the set of organizations during the online browsing session. The recommendation may be a positive recommendation, a neutral recommendation, or a negative recommendation. The positive recommendation is an option that may be an acceptable choice for the user and favorable with respect to user preferences. This has been already explained in conjunction with FIG. 1.

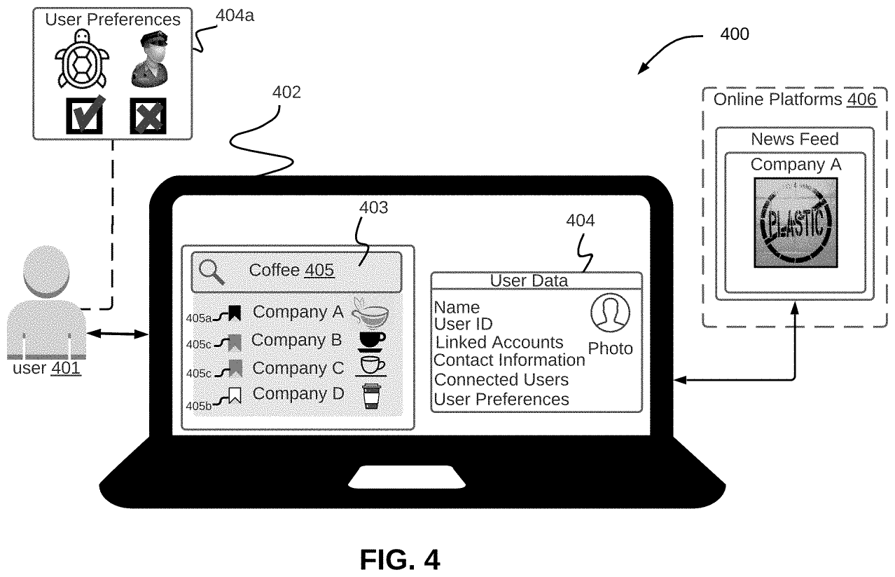

Referring now to FIG. 4, an exemplary scenario 400 for generating recommendation on a user device 402 is illustrated, in accordance with some embodiments of the present disclosure. It should be noted that the user device 402 may be a laptop and may act as a recommendation device (analogous to the recommendation device 101 and 200). In an embodiment, the user device 402 may be a device registered with a service provider for a product or a service provided by an organization. As illustrated in FIG. 4, a user 401 may search for a product or a service of interest using a search bar 403 on a search engine during an online browsing session via a user interface. Further, the user device 402 may capture user data 404 (analogues to the user data 202), and organization data (similar to the organization data 201 and not shown in FIG. 4). The user data 404 includes various details associated with the user 402. By way of an example, the user data 404 includes name of the user 401, user ID, linked accounts (for example, twitter handle, Quora account, and Pinterest account), user's contact information, connected users, influencing users' information, browsing history, and user preferences 404a. Further, the user preferences 404a of the user 401 may include that the user 401 likes sea turtles and does not like police. Further, the user 401 may be overhauled the way brands communicate and want companies to stand for something bigger than what they sell. Hence, brands that communicate their purpose and demonstrate commitment, are more likely to attract the user 401 and influence purchasing decisions of the user 401.

For example, consider a situation, where the user 401 may be thirsty and decides to order coffee online for doorstep delivery. Therefore, the user 401 may input “coffee 405” in the search bar 403 using a web browser on the user device 402. Further, after receiving the input, the user device 402 may access the online platforms 406 and may analyze news feed data and social feed data associated with companies providing services related to the doorstep delivery of coffee. In other words, the user device 402 may determine the social feed data and/or news feed data, extract one or more topics (i.e., socio-ethical causes) from the social feed data and/or news feed data, and then sentiment analysis may be performed to determine stand of each company and stand of the user 401 on one or more socio-ethical causes. As a result, the user device 402 may find in the news feed data that a company ‘A’ has stopped use of plastic recently. Thus, the user device 402 may correlate the news with user preferences 404a and consequently render a recommendation displaying the company ‘A’ at top. For example, the user 401 likes sea turtles and banning plastic may be favorable for marine life associated with the sea turtles. The user device 402 may recommend various options, such as company ‘A’ at top and followed by company ‘B’, company CB′ followed by company ‘C’, company ‘C’ followed by company ‘D’, and company ‘D’ at bottom, as illustrated in FIG. 4. In some embodiments, this sequence of displaying options may be different and each of the options may be flagged with predefined colors. For example, most favorable option is flagged with green color, unfavorable option with red color, and the like. In FIG. 4, most favorable option (i.e., Company ‘A’) is flagged with a darkest color 405a, an unfavorable option (i.e., Company ‘D’) with a lightest color 405b, and remaining options (i.e., Company ‘B’ and Company ‘C’) with another color 405c.

Consider another example, where a news of firing an employee, who refused to serve two uniformed policemen on account of police verbal abuse and brutality, by a company ‘X’ is getting viral. Further, the company ‘X’ is a burger selling company. In such case, if the user 401 searches for a burger in the search bar 403 of the search engine using the web browser, the user device 402 may display company ‘X’ as negatively flagged (not acceptable) recommendation option and/or at the bottom of the list of options. Further, if the company ‘X’ apologizes for issues and pays for the fired employee to go to college and bans on-duty policemen from their restaurants, then, for the next time when the user 401 searches for online delivery of burgers, the company ‘X’ may be listed as positively flagged or as an acceptable choice.

In other words, the company ‘X’ may have reacted quickly to developing situations of getting an employee beaten from a police officer over trivial issue by sponsoring free education of the beaten employee instead of withdrawing from the conversation or serving up bland officious statements. The company ‘X’ may have reacted instantly to allegations and adapted to changes. The disclosed system may make it easier for users to see what the values and positions of the organizations on important issues when users (such as, the user 401) are about to make a purchase online.

Yet, in another example, consider a situation where the user 401 searches for a trouser. Companies that sell trousers may have no position or stand on causes like social causes and legal causes. In that case, the search results may show default results or a neutral recommendation.

Thus, the present disclosure may help in eliminating limitation of conventional systems discussed earlier. The disclosed method and system in the present disclosure provide highly personalized experience to consumers (also referred as users) based on the causes the consumers believe in. The disclosed method and system may generate recommendations by taking into account the most desirable user behavior from organization's pre-configured stand and user's stated stand on socio-ethical causes. The disclosed method and system may take into account an adequate insight to consumer's (user's) thoughts and pattern of the consumed services. Further, the disclosed method and system may generate recommendations without human intervention, to prevent influence of unfair support or biasness. Additionally, the disclosed method and system may summarize the data associated with recommendations for users, for client companies to know how many people are talking about their products and whether the brand of the organization is making a positive impact or a negative impact on the users. Such data may further be used by organizations to develop a deeper relationship with existing customers, to develop potential customers into actual customers, and ultimately to increase sales and improve customer retention.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or process steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A method for generating recommendation for a user, the method comprising:
capturing, by a recommendation device, organization data with respect to a set of organizations and user data with respect to the user, wherein the organization data comprises at least one of brand data, product data, and services data for each organization from the set of organizations, and wherein the user data comprises a profile of the user;
determining, by the recommendation device, at least one of news feed data and social feed data from a set of online platforms, based on the organization data and the user data;
analysing, by the recommendation device, the at least one of the news feed data and the social feed data to determine stand of the each organization and stand of the user on one or more socio-ethical causes;
determining, by the recommendation device, match data associated with the user for a predefined time period, based on the user data, the organization data, and the analysis of the at least one of the news feed data and the social feed data; and
controlling, by the recommendation device, user equipment associated with the user during an online browsing session involving at least one of a product and a service offered by at least one of the set of organizations, based on the match data.

2. The method of claim 1, wherein the at least one of the news feed data and the social feed data is analysed based on a sentiment analysis model.

3. The method of claim 1, wherein controlling the user equipment comprises rendering a recommendation on the user equipment with respect to the at least one of the product and the service by the at least one of the set of organizations, and wherein the recommendation corresponds to one of a positive recommendation, a neutral recommendation, or a negative recommendation.

4. The method of claim 1, wherein the user data is indicative of the personal preferences of the user, and comprises at least one of online browsing activities of the user, preconfigured stand of the user on the one or more socio-ethical causes, demographic profile of the user, social media profiles of the user, social circle relations data of the user, and user's responsiveness to information on the internet, and wherein the organization data further comprises stated stand of the at least one of the set of organizations on the one or more socio-ethical causes, and wherein the preconfigured stand of the user or the stated stand of the at least one of the set of organizations comprises one of a pro-stand, an anti-stand and a neutral stand on the one or more socio-ethical causes.

5. The method of claim 4, wherein the user's preconfigured stand on the one or more socio-ethical causes is captured based on a user input via a first user interface.

6. The method of claim 4, wherein the stated stand of the at least one of the set of organizations is based on one or more of social profile data, organization website data, and corporate social responsibility data associated with the at least one of the set of organizations.

7. The method of claim 4, further comprising capturing a vote of the user on the stand of the at least one of the set of organizations for at least one socio-ethical cause from the one or more socio-ethical causes via a second user interface.

8. The method of claim 7, further comprising weighting the vote associated with the user based on the user data.

9. The method of claim 1, wherein the one or more socio-ethical causes are extracted from the at least one of the news feed data and the social feed data using a topic discovery model.

10. A system for generating recommendation for a user, the system comprising:
a processor; and
a memory communicatively coupled to the processor, wherein the memory stores processor-executable instructions, which, on execution, causes the processor to:
capture organization data with respect to a set of organizations and user data with respect to the user, wherein the organization data comprises at least one of brand data, product data, and services data for each organization from the set of organizations, and wherein the user data comprises a profile of the user;
determine at least one of news feed data and social feed data from a set of online platforms, based on the organization data and the user data;
analyse the at least one of the news feed data and the social feed data to determine stand of the each organization and stand of the user on one or more socio-ethical causes;
determine match data associated with the user for a predefined time period, based on the user data, the organization data, and the analysis of the at least one of the news feed data and the social feed data; and
control user equipment associated with the user during an online browsing session involving at least one of a product and a service offered by at least one of the set of organizations, based on the match data.

11. The system of claim 10, wherein the at least one of the news feed data and the social feed data is analysed based on a sentiment analysis model.

12. The system of claim 10, wherein the processor-executable instructions cause the processor to control the user equipment by rendering a recommendation on the user equipment with respect to the at least one of the product and the service by the at least one of the set of organizations, and wherein the recommendation corresponds to one of a positive recommendation, a neutral recommendation, or a negative recommendation.

13. The system of claim 10, wherein the user data is indicative of the personal preferences of the user, and comprises at least one of online browsing activities of the user, preconfigured stand of the user on the one or more socio-ethical causes, demographic profile of the user, social media profiles of the user, social circle relations data of the user, and user's responsiveness to information on the internet, and wherein the organization data further comprises stated stand of the at least one of the set of organizations on the one or more socio-ethical causes, and wherein the preconfigured stand of the user or the stated stand of the at least one of the set of organizations comprises one of a pro-stand, an anti-stand and a neutral stand on the one or more socio-ethical causes.

14. The system of claim 13, wherein the user's preconfigured stand on the one or more socio-ethical causes is captured based on a user input via a first user interface.

15. The system of claim 13, wherein the stated stand of the at least one of the set of organizations is based on one or more of social profile data, organization website data, and corporate social responsibility data associated with the at least one of the set of organizations.

16. The system of claim 13, wherein the processor executable instructions further cause the processor to capture a vote of the user on the stand of the at least one of the set of organizations for at least one socio-ethical cause from the one or more socio-ethical causes via a second user interface.

17. The method of claim 16, wherein the processor executable instructions further cause the processor to weight the vote associated with the user based on the user data.

18. The system of claim 10, wherein the one or more socio-ethical causes are extracted from the at least one of the news feed data and the social feed data using a topic discovery model.

19. A non-transitory computer-readable medium storing computer-executable instruction for generating recommendation for a user, the computer-executable instructions configured for:
capturing organization data with respect to a set of organizations and user data with respect to the user, wherein the organization data comprises at least one of brand data, product data, and services data for each organization from the set of organizations, and wherein the user data comprises a profile of the user;
determining at least one of news feed data and social feed data from a set of online platforms, based on the organization data and the user data;
analysing the at least one of the news feed data and the social feed data to determine stand of the each organization and stand of the user on one or more socio-ethical causes;
determining match data associated with the user for a predefined time period, based on the user data, the organization data, and the analysis of the at least one of the news feed data and the social feed data; and
controlling user equipment associated with the user during an online browsing session involving at least one of a product and a service offered by at least one of the set of organizations, based on the match data.

20. The non-transitory computer-readable medium of the claim 19, wherein controlling the user equipment comprises rendering a recommendation on the user equipment with respect to the at least one of the product and the service by the at least one of the set of organizations, and wherein the recommendation corresponds to one of a positive recommendation, a neutral recommendation, or a negative recommendation.
